(19) United States
(12) Patent Application Publication
(10) Pub. No.: US 2025/0117741 A1
(43) Pub. Date: Apr. 10, 2025

(54) GRAPHICAL USER INTERFACE ELEMENTS FOR ENABLING EFFICIENT LAYOUTS

(71) Applicant: EkTech Bros Inc., Austin, TX (US)

(72) Inventors: Eric Gelles, Austin, TX (US); Teo Gelles, Austin, TX (US)

(21) Appl. No.: 18/377,156

(22) Filed: Oct. 5, 2023

(51) Int. Cl. G06Q 10/087; G06F 9/451

(52) U.S. Cl. CPC G06Q 10/087; G06F 9/451

(57) ABSTRACT

A GUI to enable efficient and streamlined inventory management through responsibility assignments and checks. The unique design of the assignment system allows users of appropriate skill to be given responsibility for inventory they are familiar with and within their ability. This system retains responsibility tracking throughout multiple levels of a predefined hierarchy. In addition, the system is able to associate subcomponents with finished products along with assigning serial numbers to the finished product. In addition, the subcomponents are associated with specific finished products and their serial numbers. Finally, the system is able to check a single type of subcomponent across all assigned finished products before moving onto the next subcomponent within that finished product.

### CROSS-REFERENCE TO RELATED APPLICATIONS

None.

### BACKGROUND

### Field of Art

This invention is related to an inventory management system. More specifically, this invention is related to conducting inventory management within a hierarchy and through a parallel checking process.

### Background

Inventory management within organizations and businesses is an important task in order to maintain knowledge of both the on hand inventory and the quality of that inventory. Many management systems are able to accomplish this by allowing registered users to change the on hand and on order inventory quantities through use of graphical user interfaces. These interfaces allow a user to easily navigate through an inventory check by allowing an individual to perform counts and update that information in a connected database. However, many of these systems do not track which users are associated with specific inventory items and many users may not be familiar with all the different types of inventory that is available at a location. Because of this unfamiliarity, errors can occur in the counting process and tracking which user is responsible for the error can be difficult. Some inventory management systems try to fix this by only allowing specific trained users access to the management system, but tracking errors can still occur in these systems.

Many GUI's allow for the counting of discrete inventory items. Usually for completed or finished products. Some systems allow for the counting of materials used to make these finished products, but it can be difficult to associate specific components with their finished products. Further complicating the issue, some finished products have serial numbers associated with them. These serial numbered products need to be evaluated individually and many inventory management systems are unable to make this type of delineation between products with various serial numbers. This can lead to confusion when components for one serial number are accidentally counted as part of another serial number. Other systems in use can associate components with finished products, but fail to account for specific serial numbers.

Some inventory systems may try to solve this problem by restricting subcomponent counting to only within a finished product. When counting subcomponents with associated final products that have distinct serial numbers, the process will require verification of every subcomponent within a finished product before moving onto the next distinct final product with a serial number. These steps can be beneficial to helping distinguish inventory between serial numbers, but if the correct and incorrect subcomponents are similar in design this may cause confusion for users as they are constantly having to compare varied subcomponents quickly without error. Some inventory systems try to use images of subcomponents to simplify this process. These images still fail to provide assistance when the subcomponents look similar.

### SUMMARY

The GUI in the present invention remedies the problems that are still present in the current day solutions for inventory management. The unique design of the assignment system allows users of appropriate skill to be given responsibility for inventory they are familiar with and within their ability. This system retains responsibility tracking throughout multiple levels of hierarchy. In addition, the system is able to associate subcomponents with finished products along with assigning serial numbers to the finished product. In addition, the subcomponents are associated with specific finished products and their serial numbers. Finally, the system is able to check a single type of subcomponent across all assigned finished products before moving onto the next subcomponent within that finished product.

The inventory management system in the present invention is able to manage inventory assignments between a hierarchy of users. These users can have subordinates and the subordinates to a first user may also have subordinates. This hierarchical relationship can extend through any number of levels. This allows an organization made up of many hierarchies to have a greater knowledge of the status of inventory items throughout the hierarchy.

The inventory management system is also capable of keeping track of subcomponents that make up distinct final inventory products that also have distinct serial numbers. This level of inventory organization helps users keep track of shortages and surpluses within their inventory and confirm shortages or overages or completeness of specific final products.

The inventory management system of the present invention has a unique and novel method of performing checks on inventory that has serial numbers and subcomponents. The system checks each subcomponent type (e.g. a battery, a charger, a screen) for all final products in a set, (e.g. a group of similar items which can be classified together such as a group of laptops) wherein each final product may have a unique serial number, before moving to the next subcomponent. For example, the system checks a first subcomponent (e.g. the battery) for each laptop in a group of laptops, then proceeds to a second subcomponent (e.g. a charger) for each laptop in the group and so on until each subcomponent has been checked across all items in the set of final products. After the set of final products have been checked, the system moves onto the next set of final products, repeating the above sequence.

Unlike inventory management done on pen and paper systems or other electronic systems, the current invention provides helpful prompts for the different subcomponents. In addition, conventional inventory checks are performed by analyzing all subcomponents within an individual final product before continuing onto the next final product. For example, the system will check all subcomponents (e.g. a battery, screen, and charger) within a single final product (e.g. a laptop), before continuing onto the next single final product and checking all the subcomponents within the final product.

### BRIEF DESCRIPTION OF THE DRAWING FIGURES

The accompanying drawings illustrate several embodiments and, together with the description, serve to explain the principles of the invention according to the embodiments. It will be appreciated by one skilled in the art that the particular arrangements illustrated in the drawings are merely exemplary and are not to be considered as limiting of the scope of the invention or the claims herein in any way.

FIG. 1 illustrates a system diagram for an exemplary embodiment of a inventory management system

FIGS. 2a-2c illustrates graphical user interfaces for an exemplary embodiment of a inventory management system and responsibility assignment

FIG. 3a-3c illustrates graphical user interfaces for an exemplary embodiment of a inventory management system and inventory check

FIG. 4 illustrates one embodiment of the computing architecture that supports an embodiment of the inventive disclosure.

FIG. 5 illustrates components of a system architecture that supports an embodiment of the inventive disclosure.

FIG. 6 illustrates components of a computing device that supports an embodiment of the inventive disclosure.

FIG. 7 illustrates components of a computing device that supports an embodiment of the inventive disclosure.

### DETAILED DESCRIPTION OF EMBODIMENTS

The GUI in the present invention remedies the problems that are still present in the current day solutions for inventory management. The unique design of the assignment system allows users to keep track of inventory and the status of the specific items. This system retains responsibility tracking throughout multiple levels of hierarchy. In addition, the system is able to associate subcomponents with finished products along with assigning serial numbers to the finished product. In addition, the subcomponents are associated with specific finished products and their serial numbers. Finally, the system is able to check a single type of subcomponent across all assigned finished products before moving onto the next subcomponent within that finished product.

One or more different embodiments may be described in the present application. Further, for one or more of the embodiments described herein, numerous alternative arrangements may be described; it should be appreciated that these are presented for illustrative purposes only and are not limiting of the embodiments contained herein or the claims presented herein in any way. One or more of the arrangements may be widely applicable to numerous embodiments, as may be readily apparent from the disclosure. In general, arrangements are described in sufficient detail to enable those skilled in the art to practice one or more of the embodiments, and it should be appreciated that other arrangements may be utilized and that structural, logical, software, electrical and other changes may be made without departing from the scope of the embodiments. Particular features of one or more of the embodiments described herein may be described with reference to one or more particular embodiments or figures that form a part of the present disclosure, and in which are shown, by way of illustration, specific arrangements of one or more of the aspects. It should be appreciated, however, that such features are not limited to usage in the one or more particular embodiments or figures with reference to which they are described. The present disclosure is neither a literal description of all arrangements of one or more of the embodiments nor a listing of features of one or more of the embodiments that must be present in all arrangements.

Headings of sections provided in this patent application and the title of this patent application are for convenience only and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible embodiments and in order to more fully illustrate one or more embodiments. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the embodiments, and does not imply that the illustrated process is preferred. Also, steps are generally described once per aspect, but this does not mean they must occur once, or that they may only occur once each time a process, method, or algorithm is carried out or executed. Some steps may be omitted in some embodiments or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various embodiments in which, for example, functions may be executed out of order from that shown or discussed, including substantially concurrently or in reverse order, depending on the functionality involved, as would be understood by those having ordinary skill in the art.

The detailed description set forth herein in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

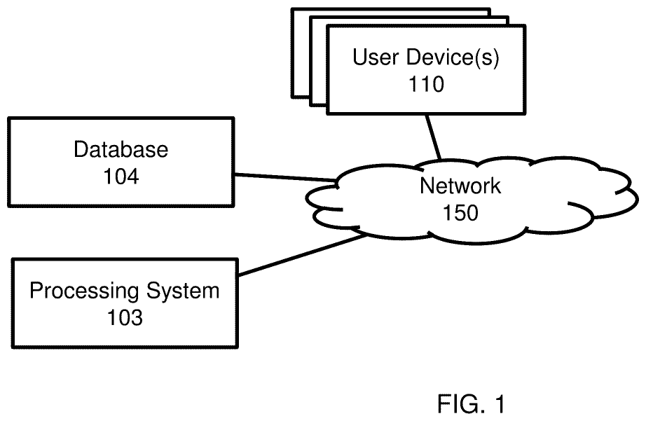

FIG. 1 illustrates a system for inventory management. The system comprises a processing system 103, a database 104, a user device(s) 110, and a network 150.

The processing system 103 is used to execute and display the user interface. This processing system is capable of communicating with databases that may be connected over an electronic network 150. The processing system is in an exemplary embodiment, but not limited to, is a microprocessor, but other equivalent systems known to those skilled in the art may be used.

The database 104 may comprise an address, such as an Internet Protocol (IP) address or a Uniform Resource Locator (URL), associated with an inventory list or hierarchy assignment platform. The database 104 may comprise one or more computing device(s). The database 104 may comprise a cloud computing environment. The database 104 may comprise a distributed computing environment. The database 104 may host a website. The database 104 may host a web application. The database 104 may provide applications, such as mobile applications, for download by the user device 110 via the network 150. The database 104 may receive communications from and transmit communications to the user device 110 via the network 150.

User device(s) 110 include, generally, a computer or computing device including functionality for communicating (e.g., remotely) over a network 150. Data may be collected from user devices 110, and data requests may be initiated from each user device 110. User device(s) 110 may be a server, a desktop computer, a laptop computer, personal digital assistant (PDA), an in- or out-of-car navigation system, a smart phone or other cellular or mobile phone, or mobile gaming device, among other suitable computing devices. User devices 110 may execute one or more applications, such as a web browser (e.g., Microsoft Windows Internet Explorer, Mozilla Firefox, Apple Safari, Google Chrome, and Opera, etc.), or a dedicated application to submit user data, or to make prediction queries over a network 150.

In particular embodiments, each user device 110 may be an electronic device including hardware, software, or embedded logic components or a combination of two or more such components and capable of carrying out the appropriate functions implemented or supported by the user device 110. For example and without limitation, a user device 110 may be a ruggedized tablet, a desktop computer system, a notebook computer system, a netbook computer system, a handheld electronic device, or a mobile telephone. The present disclosure contemplates any user device 110. A user device 110 may enable a network user at the user device 110 to access network 150. A user device 110 may enable its user to communicate with other users at other user devices 110.

A user device 110 may have a web browser, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user device 110 may enable a user to enter a Uniform Resource Locator (URL) or other address directing the web browser to a server, and the web browser may generate a Hyper Text Transfer Protocol (HTTP) request and communicate the HTTP request to server. The server may accept the HTTP request and communicate to the user device 110 one or more Hyper Text Markup Language (HTML) files responsive to the HTTP request. The user device 110 may render a web page based on the HTML files from server for presentation to the user. The present disclosure contemplates any suitable web page files. As an example and not by way of limitation, web pages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a web page encompasses one or more corresponding web page files (which a browser may use to render the web page) and vice versa, where appropriate.

The user device 110 may also include an application that is loaded onto the user device 110. The application obtains data from the network 150 and displays it to the user within the application interface.

Exemplary user devices are illustrated in some of the subsequent figures provided herein. This disclosure contemplates any suitable number of user devices, including computing systems taking any suitable physical form. As example and not by way of limitation, computing systems may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, or a combination of two or more of these. Where appropriate, the computing system may include one or more computer systems; be unitary or distributed; span multiple locations; span multiple machines; or reside in a cloud, which may include one or more cloud components in one or more networks. Where appropriate, one or more computing systems may perform without substantial spatial or temporal limitation one or more steps of one or more methods described or illustrated herein. As an example, and not by way of limitation, one or more computing systems may perform in real time or in batch mode one or more steps of one or more methods described or illustrated herein. One or more computing system may perform at different times or at different locations one or more steps of one or more methods described or illustrated herein, where appropriate.

Network cloud 150 generally represents a network or collection of networks (such as the Internet or a corporate intranet, or a combination of both) over which the various components illustrated in FIG. 1 (including other components that may be necessary to execute the system described herein, as would be readily understood to a person of ordinary skill in the art). In particular embodiments, network 150 is an intranet, an extranet, a virtual private network (VPN), a local area network (LAN), a wireless LAN (WLAN), a wide area network (WAN), a metropolitan area network (MAN), a portion of the Internet, or another network 150 or a combination of two or more such networks 150. One or more links connect the systems and databases described herein to the network 150. In particular embodiments, one or more links each includes one or more wired, wireless, or optical links. In particular embodiments, one or more links each includes an intranet, an extranet, a VPN, a LAN, a WLAN, a WAN, a MAN, a portion of the Internet, or another link or a combination of two or more such links. The present disclosure contemplates any suitable network 150, and any suitable link for connecting the various systems and databases described herein.

The network 150 connects the various systems and computing devices described or referenced herein. In particular embodiments, network 150 is an intranet, an extranet, a virtual private network (VPN), a local area network (LAN), a wireless LAN (WLAN), a wide area network (WAN), a metropolitan area network (MAN), a portion of the Internet, or another network 421 or a combination of two or more such networks 150. The present disclosure contemplates any suitable network 150.

One or more links couple one or more systems, engines or devices to the network 150. In particular embodiments, one or more links each includes one or more wired, wireless, or optical links. In particular embodiments, one or more links each includes an intranet, an extranet, a VPN, a LAN, a WLAN, a WAN, a MAN, a portion of the Internet, or another link or a combination of two or more such links. The present disclosure contemplates any suitable links coupling one or more systems, engines or devices to the network 150.

In particular embodiments, each system or engine may be a unitary server or may be a distributed server spanning multiple computers or multiple datacenters. Systems, engines, or modules may be of various types, such as, for example and without limitation, web server, news server, mail server, message server, advertising server, file server, application server, exchange server, database server, or proxy server. In particular embodiments, each system, engine or module may include hardware, software, or embedded logic components or a combination of two or more such components for carrying out the appropriate functionalities implemented or supported by their respective servers. For example, a web server is generally capable of hosting websites containing web pages or particular elements of web pages. More specifically, a web server may host HTML files or other file types, or may dynamically create or constitute files upon a request, and communicate them to client/user devices or other devices in response to HTTP or other requests from client devices or other devices. A mail server is generally capable of providing electronic mail services to various client devices or other devices. A database server is generally capable of providing an interface for managing data stored in one or more data stores.

In particular embodiments, one or more data storages may be communicatively linked to one or more servers via one or more links. In particular embodiments, data storages may be used to store various types of information. In particular embodiments, the information stored in data storages may be organized according to specific data structures. In a particular embodiment, each data storage may be a relational database. Particular embodiments may provide interfaces that enable servers or clients to manage, e.g., retrieve, modify, add, or delete, the information stored in data storage.

The system may also contain other subsystems and databases, which are not illustrated in FIG. 1, but would be readily apparent to a person of ordinary skill in the art. For example, the system may include multiple databases to store data about hierarchical assignments and inventory data. Other databases and systems may be added or subtracted, as would be readily understood by a person of ordinary skill in the art, without departing from the scope of the invention.

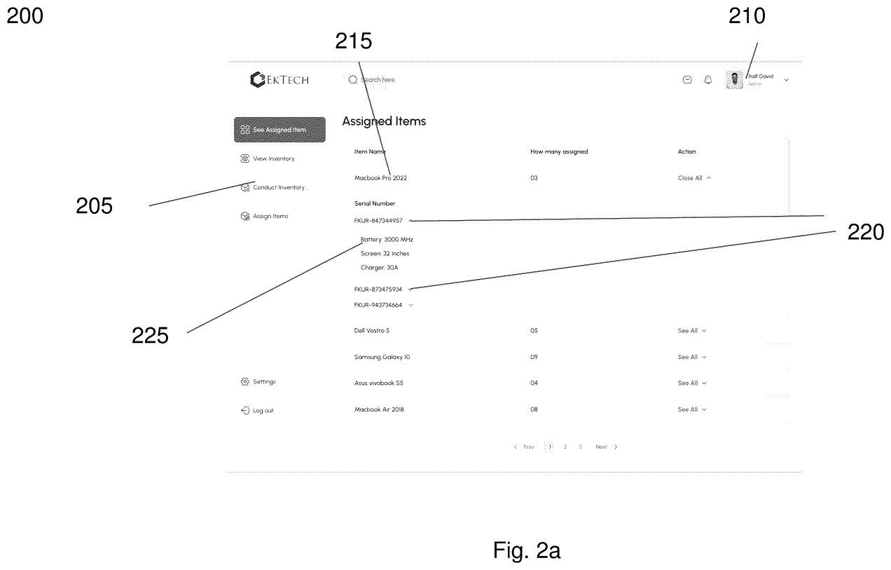

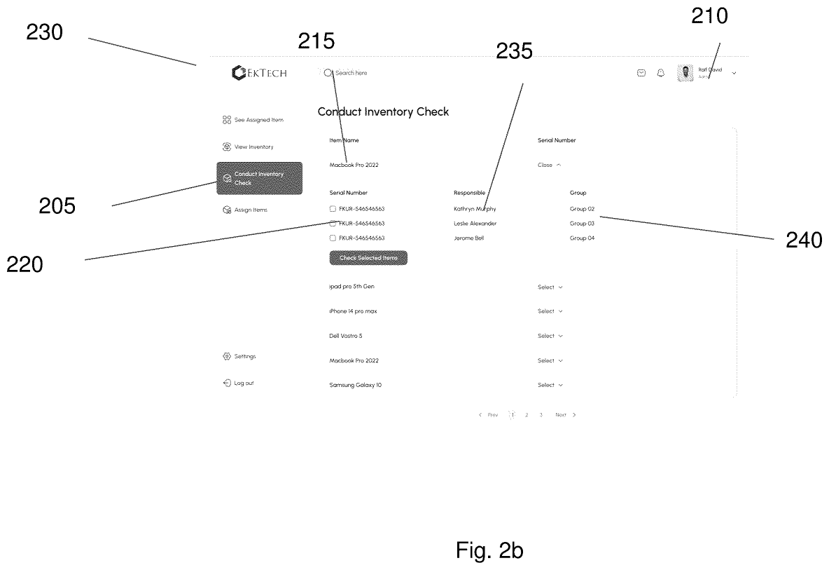

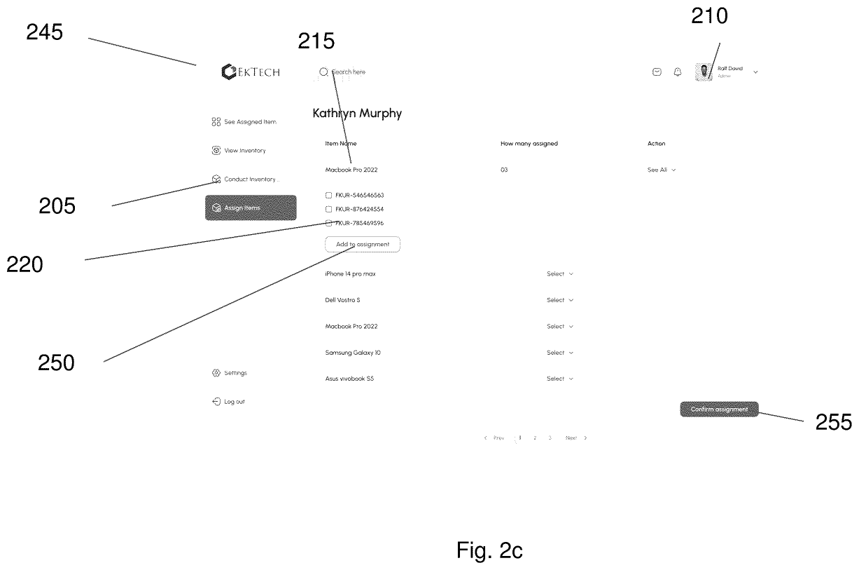

FIG. 2a illustrates an example graphical user interface for showing user assigned items. The computing environment may comprise an assigned items user interface 200, a selectable menu 205, a user indicator display 210, a final product interface 215, a serial number(s) interface 220, and a subcomponent(s) display 225.

The assigned items user interface 200 is a display for a user to view any inventory items assigned to them. This list may be contained on the user device 110 or the database 104. The assigned items user interface 200, comprises at least one interactive interface. The interactive interface comprises at least one list. The interactive interface may compromise at least one sub list. In an embodiment of the invention, these lists and sub lists are displayed as a series of indented lists to indicate relationships between each of the lists, however one of ordinary skill in the art would be able to utilize other list and sub list displays for example, but not limited to, a pull down interactive element. The assigned items user interface 200 may comprise an action interface. In an embodiment of the invention this action interface will allow the user to to collapse or alternatively display all or some of the sub lists associated with at least one final product. The assigned items user interface 200 may comprise a navigation interface. The navigation interface may allow a user to quickly select another page of the list of assigned items or cycle backwards and forwards through the pages. The assigned items user interface 200 may comprise a search interface. This search interface will allow the user to input a text based search query in and confirm a search. Once the search is confirmed the assigned items user interface 200 will display a series of search results related to the search query. The search interface may also retain a history of the search queries input by the user.

The selectable menu 205 may be an interactive display that shows a list of selectable interfaces. In an exemplary embodiment of the invention, the list comprises, but is not limited to at least one of “See assigned item,” “View Inventory,” “Conduct inventory check,” and “assign items.” These interfaces can be selected by a user to change the user interface display to another display. In addition, a settings interface may be selectable by a user to adjust settings for the user interface. In an embodiment of the invention, the settings can include, but are not limited to, changing text properties. Furthermore, there may be a log out interface that allows the user to sign out of the user interface. The list of selectable interfaces may be accessed/displayed via a selectable drop down interface.

The user indicator display 210 may be a display that shows the current user information and related information. The current user information may at least, but is not limited to the name of the user, the title of the user, and a picture of the user. In addition, an interactive interface may be provided that provides a visual alert for the user if there are any errors or points of interest and interaction with the interface, will display a list of alerts. Also, a mail interactive interface may be provided that provides a visual alert for the user if they have received any messages. Interaction with the mail interactive interface will allow the user to send and receive messages to other users.

The final product interface 215 may be an interactive display that allows a user to quickly view any final products assigned to them. In an embodiment of the invention, the list may display a series of final product interfaces arranged vertically that show the final products assigned to the user. The final product interface 215 may also display how many of these final products are assigned to the user. The different final product interfaces 215 may be selectable by a user to bring up a sub list of the serial number interfaces 220. Alternatively, the final product interface 215 may be displayed with an image of the final product or an identifying code such as a barcode or QR code.

The serial number(s) interface 220 may be an interactive display that allows a user to quickly view any serial numbers of a selected final product that are assigned to the user. The sublist of serial number interfaces 220 may display the unique serial numbers associated with the final product interface in a vertical list that is indented from the final product interface 215 that are assigned to the user. When a user interacts with a serial number interface 220, a sub list of subcomponent displays 225 are shown to the user. Alternatively, the serial number(s) interface 220 may be displayed with an identifying code such as a barcode or QR code for the serial numbers.

The subcomponent(s) display 225 may be a display that allows a user to quickly view any subcomponents for the serial numbers of a selected final product that are assigned to the user. The subcomponent displays may comprise an indented list of the subcomponents that make up the selected serial number interface. Alternatively, the subcomponent(s) display 225 may be displayed with an image of the subcomponent.

FIG. 2b illustrates an example graphical user interface for showing subordinate assigned items. The computing environment may comprise a subordinate inventory check user interface 230, a selectable menu 205, a user indicator display 210, an end item display 215, a serial number(s) display 220, subordinate(s) display 235, and a group assignment(s) display 240.

The subordinate inventory check user interface 230 may be a display that allows a user to conduct an inventory check for inventory items that are assigned to a subordinate. The subordinate inventory check user interface 230 may display a series of lists and interactive elements that allows a user to select these items and then be directed towards an user interface display for performing an inventory check based on the selected items. These lists and sub lists in an embodiment of the invention are displayed as a series of indented lists and columns to indicate relationships between each of the lists, however one of ordinary skill in the art would be able to utilize other list and sub list displays for example, but not limited to, a pull down interactive element. The subordinate inventory check user interface 230 may also comprise a sublist interface. In an embodiment of the invention this action interface will allow the user to to collapse or alternatively display all or some of the sub lists associated with at least one final product. The subordinate inventory check user interface 230 may also contain a navigation interface. The navigation interface may allow a user to quickly select another page of the list of assigned items or cycle backwards and forwards through the pages. The subordinate inventory check user interface 230 may also contain a search interface. This search interface will allow the user to input a text based search query in and confirm a search. Once the search is confirmed the subordinate inventory check user interface 230 will display a series of search results related to the search query. The search interface may also retain a history of the search queries input by the user.

The subordinate(s) display 235 may be a sub list that allows a user to quickly view the responsibility of a serial number interface to at least one user. The subordinate(s) display 235 may comprise assigned user information that comprises, but is not limited to, a name, rank, or image of the assigned user.

The group assignment(s) display 240 may be a sub list that allows a user to quickly view the responsibility of a serial number interface to at least one group. The group assignment(s) display 240 may comprise assigned user information that comprises, but is not limited to at least one of a name, number, image, and code of the assigned group.

FIG. 2c illustrates an example graphical user interface for showing and modifying subordinate assigned items. The computing environment may comprise a subordinate assignment user interface 245, a selectable menu 205, a user indicator display 210, an end item display 215, a serial number(s) display 220, an add to assignment interface 250 and an assignment confirmation interface 255

The subordinate assignment user interface 245 may be a display that allows a user to assign responsibility for a serial number to a subordinate user. The subordinate assignment user interface 245 may display the subordinate's identifying information as a header to the interface. The subordinate assignment user interface 245 may display a series of lists and interactive elements that allows a user to select these items and then select an add to assignment interface that assigns responsibility for the serial numbers to a subordinate. These lists and sub lists in an embodiment of the invention are displayed as a series of indented lists and columns to indicate relationships between each of the lists, however one of ordinary skill in the art would be able to utilize other list and sub list displays for example, but not limited to, a pull down interactive element. The subordinate assignment user interface 245 may comprise a sublist interface. In an embodiment of the invention this action interface will allow the user to to collapse or alternatively display all or some of the sub lists associated with at least one final product. The subordinate assignment user interface 245 may also contain a navigation interface. The navigation interface may allow a user to quickly select another page of the list of assigned items or cycle backwards and forwards through the pages. The subordinate assignment user interface 245 may also contain a search interface. This search interface will allow the user to input a text based search query in and confirm a search. Once the search is confirmed the subordinate assignment user interface 245 will display a series of search results related to the search query. The search interface may also retain a history of the search queries input by the user.

The add to assignment interface 250 may be a selectable user interface that, in an embodiment of this invention, allows a user to select a series of serial numbers with check boxes and then select an verification interface to assign responsibility of the selected serial numbers to the subordinate. Alternatively, the add to assignment interface 250 may operate without confirmation and simply selecting a serial number may assign it to the subordinate user.

The assignment confirmation interface 255 may be an interface that is used to finalize assignments made by the add to assignment interface 250. When a user interacts with the assignment confirmation interface 255, the assignment data in the database 104 is updated to reflect the selections made by the user. Alternatively, the add to assignment interface 250 may operate without confirmation and simply selecting a serial number may assign it to the subordinate user.

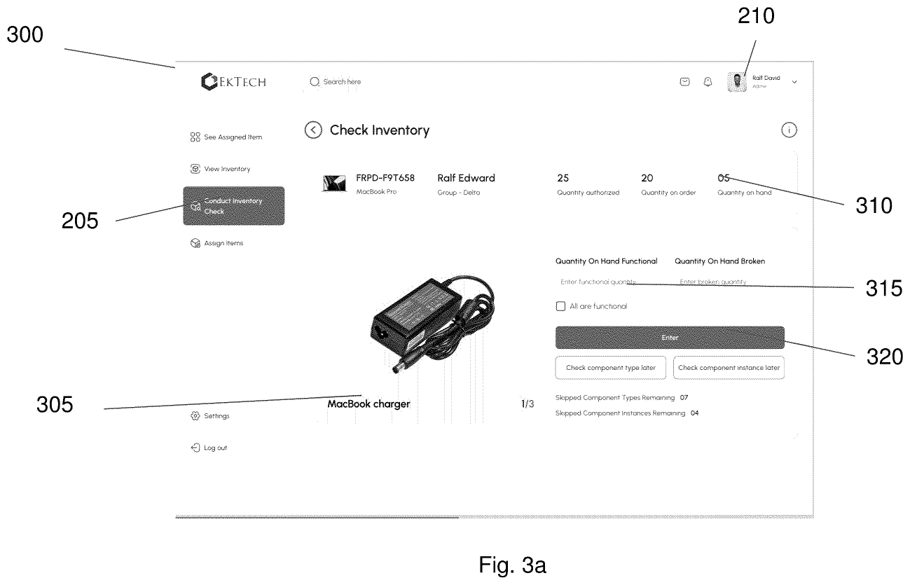

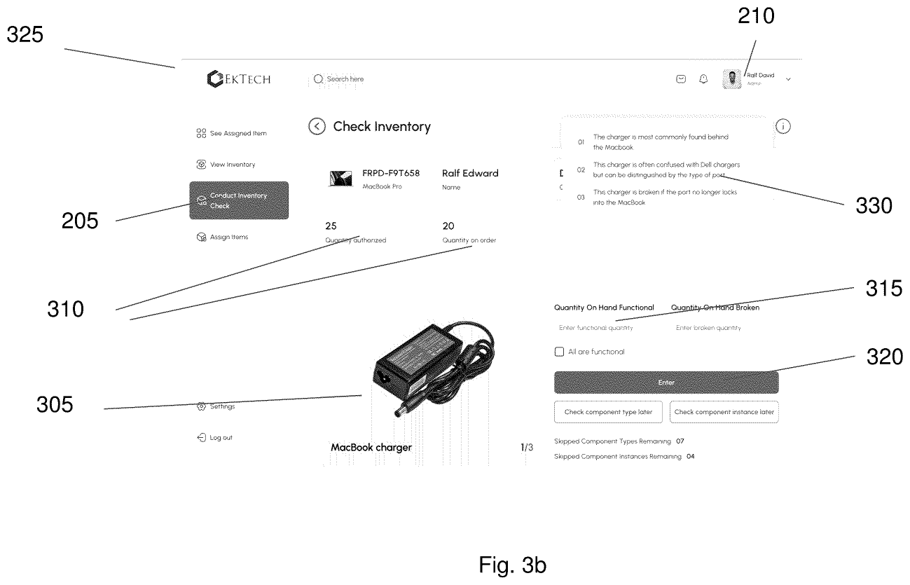

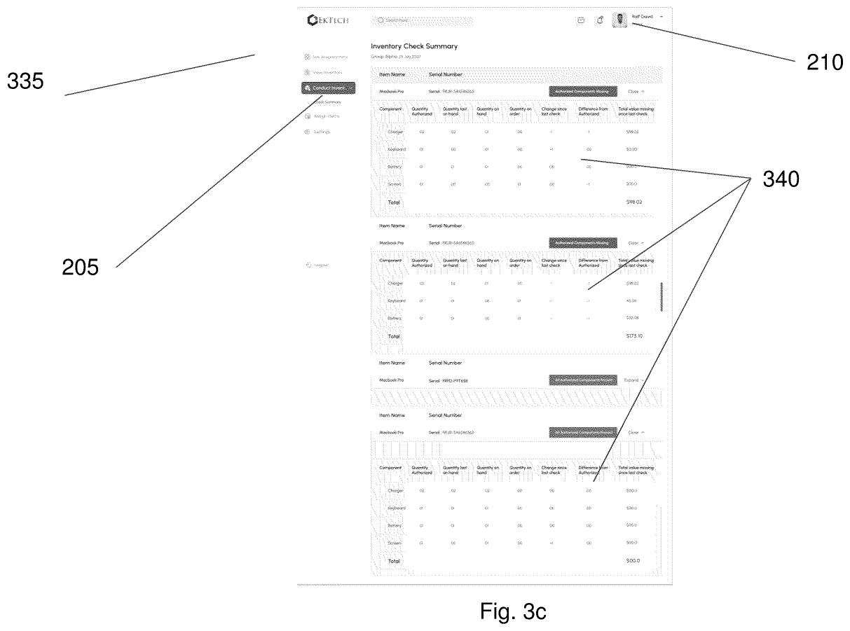

FIG. 3a illustrates an example graphical user interface for conducting an inventory check. The computing environment may comprise an inventory check interface 300, a selectable menu 205, a user indicator display 210, a subcomponent information interface 305, an inventory history display 310, an inventory quantity interface 315, and an inventory selection interface 320.

The inventory check interface 300 may be a display that allows a user to conduct an inventory check. The inventory check interface 300 comprises a series of interfaces that may display quantities associated with subcomponents and the ability to manipulate those quantities. The inventory check interface 300 may also contain a search interface. This search interface will allow the user to input a text based search query in and confirm a search. Once the search is confirmed the inventory check interface 300 will display a series of search results related to the search query. The search interface may also retain a history of the search queries input by the user. Alternatively, after a user finishes an interaction with the inventory check interface 300, a report may be generated that informs the user what items or tasks they have failed to find or complete.

The subcomponent information interface 305 displays subcomponent information about the subcomponent the user is currently performing a check on. This subcomponent information may include, but is not limited to, at least one image displaying different views of a subcomponent, codes or identifiers related to the subcomponent, or total number of subcomponent types remaining in the inventory check. Alternatively, the subcomponent information interface 305, may be omitted in the inventory check interface 300 to direct focus to other elements of the inventory check interface 300.

The inventory history display 310 may be a display of historical inventory information and related assignment information. The inventory history display 310 may display inventory information that comprises, but is not limited to, serial number of the final product that is related to the subcomponent, subordinate assignments, subordinate groups, quantity authorized, quantity on order, and quantity on hand from the previous inventory check.

The inventory quantity interface 315 may be at least one interactive element that a user can interact with to update quantities related to the subcomponents related to the serial numbers of the final products assigned to the user. The interactive elements may comprise at least one box or pull down menu or other selectable elements known to those in the art that allow the user to input a number. The boxes may comprise, but not be limited to, the quantity on hand functional and the quantity on hand broken. The inventory quantity interface 315 may also contain an interactive element that may comprise, but is not limited to, a check box to indicate all of the subcomponents are functional.

The inventory selection interface 320 may be at least one interactive element that allows a user to progress the inventory check when activated. The inventory selection interface 320 may comprise but is not limited to, a confirmation interface, a check component type later interface, and a check component instance later interface. During normal operation, interaction with the confirmation interface will progress the inventory check by moving onto the next serial number but keep the subcomponent display the same until all the serial numbers a user is assigned to are exhausted. Once a user completes checking the subcomponents of all the serial numbers, interaction with the confirmation interface will change the subcomponent and return to the first serial number a user is assigned. This process repeats until a user completes all the subcomponents associated with all the serial numbers they have been assigned. After the inventory check on all the serial numbers of the first final product is completed, the subcomponent information interface 305, will update to the next assigned final product, updating both the serial numbers and subcomponents appropriately. Alternatively, the inventory selection interface 320 may be omitted and have the act of setting a number into inventory quantity interface 315 may automatically progress the inventory check based on the above process. Alternatively, when a user completes interaction with the inventory selection interface 320, a new display telling the user what they are missing may be generated.

FIG. 3b illustrates an example of an enhanced graphical user interface for conducting an inventory check. The computing environment may comprise an enhanced inventory check interface 325, a selectable menu 205, a user indicator display 210, a subcomponent information display 305, an inventory history display 310, an inventory quantity interface 315, and an inventory selection interface 320, and a subcomponent assist display 330.

The enhanced inventory check interface 325 may be a user interface that allows a user to conduct an inventory check. The enhanced inventory check interface 325 comprises a series of interfaces that may display quantities associated with subcomponents and the ability to manipulate those quantities. The enhanced inventory check interface 325 may also contain a search interface. This search interface will allow the user to input a text based search query in and confirm a search. Once the search is confirmed the enhanced inventory check interface 325 will display a series of search results related to the search query. The search interface may also retain a history of the search queries input by the user. Alternatively, after a user finishes an interaction with the enhanced inventory check interface 325, a report may be generated that informs the user what items or tasks they have failed to find or complete

The subcomponent assist display 330 may be a display that provides additional information about the subcomponent related to the inventory check. The subcomponent assist display 330 may comprise additional subcomponent information that can help a user improve inventory check procedures.

FIG. 3c illustrates an example of a graphical user interface for displaying a summary for conducting an inventory check. The computing environment may comprise an summary inventory check interface 335, a selectable menu 205, a user indicator display 210, and a product information interface 340.

The summary inventory check interface 335 may be a user interface that allows a user to view the results of an inventory check. The summary inventory check interface 335 comprises a series of interfaces that may display quantities of the subcomponents associated with final products that have serial numbers. The summary inventory check interface 335 may comprise a time and/or date of the inventory check and group indicator data. The summary inventory check interface 335 may also contain a search interface. This search interface will allow the user to input a text based search query in and confirm a search. Once the search is confirmed the enhanced inventory check interface 325 will display a series of search results related to the search query. The search interface may also retain a history of the search queries input by the user.

The product information interface 340 may be a user interface that appears as at least one summary table interface. The table interface may have at least one of a final product indicator, a serial number indicator, a collapse/expand interface, a component status display, and a summary chart. The final product indicator may be a display that shows the user the name of the final product associated with the summary chart. The serial number indicator may be a display that shows the user the serial number of the final product associated with the summary chart. The collapse/expand interface may be, in an exemplary embodiment of the invention, but not limited to, a button that when a user interacts with the button, will display or hide the summary chart. The component status display may be a display that shows the user the result of the inventory check to indicate if the final product has components missing or if all components are present that are associated with the summary chart. The summary chart may comprise a table that comprises a series of rows and columns. The rows may comprise a list of subcomponents associated with the final product that has a unique serial number. The columns of the table may comprise at least one of, but is not limited to, quantity authorized, quantity last on hand, quantity on hand, quantity on order, change since last check, difference from authorized, and total value missing since last check. The quantity authorized values for the subcomponents may be populated from information stored on a database 104. The quantity on hand, quantity last on hand and quantity on order values for the subcomponents may be populated from information gained by the inventory check. The change since last check and difference from authorized values for the subcomponents may be populated from information calculated from the previous inventory data. The total value missing values for the subcomponents may be populated from information calculated and stored on the database 104 and from the inventory check. The table may also comprise a total value missing display that displays the total value of the missing subcomponents as calculated from the above information.

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments).

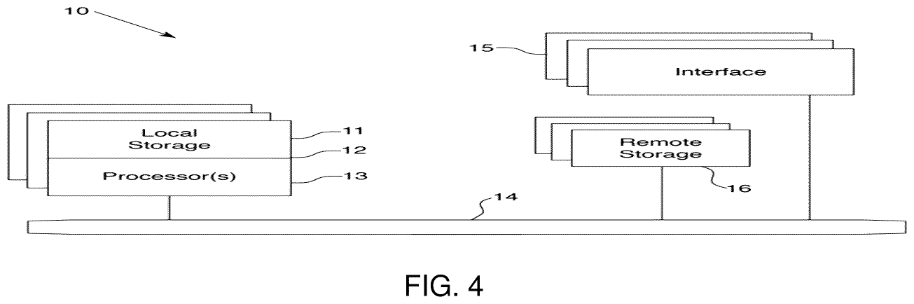

Any of the above mentioned systems, units, modules, engines, controllers, interfaces, components or the like may be and/or comprise hardware and/or software as described herein. For example, the enterprise system 101, the query wise stateless structure engine 110, the large language model (LLM) system 120, the network 150, and subcomponents thereof may be and/or comprise computing hardware and/or software as described herein in association with FIGS. 4-7. Furthermore, any of the above mentioned systems, units, modules, engines, controllers, interfaces, components or the like may use and/or comprise an application programming interface (API) for communicating with other systems units, modules, engines, controllers, interfaces, components, or the like for obtaining and/or providing data or information.

Referring now to FIG. 4, there is shown a block diagram depicting an exemplary computing device 10 suitable for implementing at least a portion of the features or functionalities disclosed herein. Computing device 10 may be, for example, any one of the computing machines listed in the previous paragraph, or indeed any other electronic device capable of executing software- or hardware-based instructions according to one or more programs stored in memory. Computing device 10 may be configured to communicate with a plurality of other computing devices, such as clients or servers, over communications networks such as a wide area network a metropolitan area network, a local area network, a wireless network, the Internet, or any other network, using known protocols for such communication, whether wireless or wired.

In one aspect, computing device 10 includes one or more central processing units (CPU) 12, one or more interfaces 15, and one or more busses 14 (such as a peripheral component interconnect (PCI) bus). When acting under the control of appropriate software or firmware, CPU 12 may be responsible for implementing specific functions associated with the functions of a specifically configured computing device or machine. For example, in at least one aspect, a computing device 10 may be configured or designed to function as a server system utilizing CPU 12, local memory 11 and/or remote memory 16, and interface(s) 15. In at least one aspect, CPU 12 may be caused to perform one or more of the different types of functions and/or operations under the control of software modules or components, which for example, may include an operating system and any appropriate applications software, drivers, and the like.

CPU 12 may include one or more processors 13 such as, for example, a processor from one of the Intel, ARM, Qualcomm, and AMD families of microprocessors. In some embodiments, processors 13 may include specially designed hardware such as application-specific integrated circuits (ASICs), electrically erasable programmable read-only memories (EEPROMs), field-programmable gate arrays (FPGAs), and so forth, for controlling operations of computing device 10. In a particular aspect, a local memory 11 (such as non-volatile random-access memory (RAM) and/or read-only memory (ROM), including for example one or more levels of cached memory) may also form part of CPU 12. However, there are many different ways in which memory may be coupled to system 10. Memory 11 may be used for a variety of purposes such as, for example, caching and/or storing data, programming instructions, and the like. It should be further appreciated that CPU 12 may be one of a variety of system-on-a-chip (SOC) type hardware that may include additional hardware such as memory or graphics processing chips, such as a QUALCOMM SNAPDRAGON™ or SAMSUNG EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one aspect, interfaces 15 are provided as network interface cards (NICs). Generally, NICs control the sending and receiving of data packets over a computer network; other types of interfaces 15 may for example support other peripherals used with computing device 10. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 15 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 4 illustrates one specific architecture for a computing device 10 for implementing one or more of the embodiments described herein, it is by no means the only device architecture on which at least a portion of the features and techniques described herein may be implemented. For example, architectures having one or any number of processors 13 may be used, and such processors 13 may be present in a single device or distributed among any number of devices. In one aspect, single processor 13 handles communications as well as routing computations, while in other embodiments a separate dedicated communications processor may be provided. In various embodiments, different types of features or functionalities may be implemented in a system according to the aspect that includes a client device (such as a tablet device or smartphone running client software) and server systems (such as a server system described in more detail below).

Regardless of network device configuration, the system of an aspect may employ one or more memories or memory modules (such as, for example, remote memory block 16 and local memory 11) configured to store data, program instructions for the general-purpose network operations, or other information relating to the functionality of the embodiments described herein (or any combinations of the above). Program instructions may control execution of or comprise an operating system and/or one or more applications, for example. Memory 16 or memories 11, 16 may also be configured to store data structures, configuration data, encryption data, historical system operations information, or any other specific or generic non-program information described herein.

Because such information and program instructions may be employed to implement one or more systems or methods described herein, at least some network device embodiments may include nontransitory machine-readable storage media, which, for example, may be configured or designed to store program instructions, state information, and the like for performing various operations described herein. Examples of such nontransitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a JAVA™ compiler and may be executed using a Java virtual machine or equivalent, or files containing higher level code that may be executed by the computer using an interpreter (for example, scripts written in Python, Perl, Ruby, Groovy, or any other scripting language).

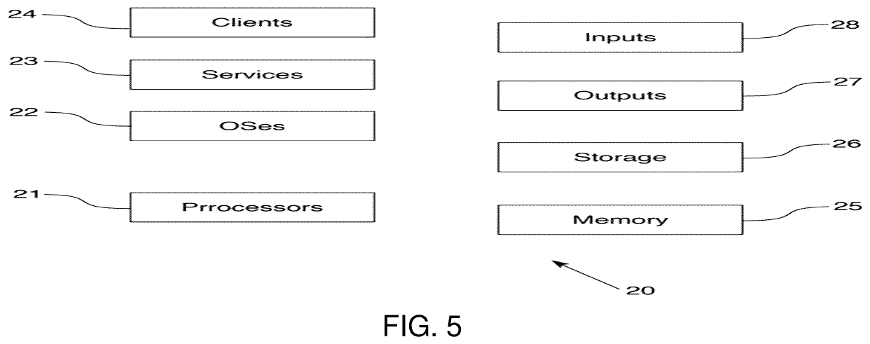

In some embodiments, systems may be implemented on a standalone computing system. Referring now to FIG. 5, there is shown a block diagram depicting a typical exemplary architecture of one or more embodiments or components thereof on a standalone computing system. Computing device 20 includes processors 21 that may run software that carry out one or more functions or applications of embodiments, such as for example a client application. Processors 21 may carry out computing instructions under control of an operating system 22 such as, for example, a version of MICROSOFT WINDOWS™ operating system, APPLE macOS™ or iOS™ operating systems, some variety of the Linux operating system, ANDROID™ operating system, or the like. In many cases, one or more shared services 23 may be operable in system 20, and may be useful for providing common services to client applications. Services 23 may for example be WINDOWS™ services, user-space common services in a Linux environment, or any other type of common service architecture used with operating system 21. Input devices 28 may be of any type suitable for receiving user input, including for example a keyboard, touchscreen, microphone (for example, for voice input), mouse, touchpad, trackball, or any combination thereof. Output devices 27 may be of any type suitable for providing output to one or more users, whether remote or local to system 20, and may include for example one or more screens for visual output, speakers, printers, or any combination thereof. Memory 25 may be random-access memory having any structure and architecture known in the art, for use by processors 21, for example to run software. Storage devices 26 may be any magnetic, optical, mechanical, memristor, or electrical storage device for storage of data in digital form (such as those described above, referring to FIG. 4). Examples of storage devices 26 include flash memory, magnetic hard drive, CD-ROM, and/or the like.

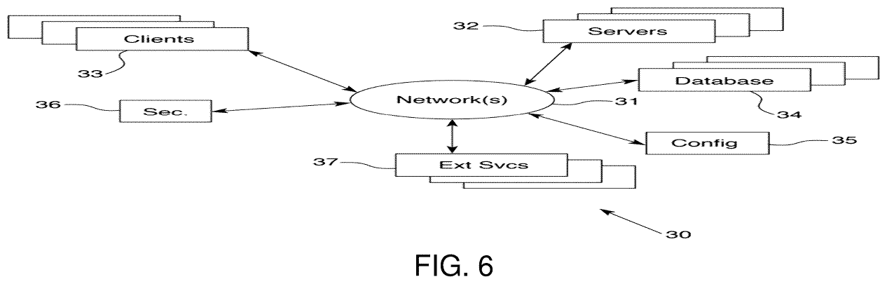

In some embodiments, systems may be implemented on a distributed computing network, such as one having any number of clients and/or servers. Referring now to FIG. 6, there is shown a block diagram depicting an exemplary architecture 30 for implementing at least a portion of a system according to one aspect on a distributed computing network. According to the aspect, any number of clients 33 may be provided. Each client 33 may run software for implementing client-side portions of a system; clients may comprise a system 20 such as that illustrated in FIG. 5. In addition, any number of servers 32 may be provided for handling requests received from one or more clients 33. Clients 33 and servers 32 may communicate with one another via one or more electronic networks 31, which may be in various embodiments any of the Internet, a wide area network, a mobile telephony network (such as CDMA or GSM cellular networks), a wireless network (such as WiFi, WiMAX, LTE, and so forth), or a local area network (or indeed any network topology known in the art; the aspect does not prefer any one network topology over any other). Networks 31 may be implemented using any known network protocols, including for example wired and/or wireless protocols.

In addition, in some embodiments, servers 32 may call external services 37 when needed to obtain additional information, or to refer to additional data concerning a particular call. Communications with external services 37 may take place, for example, via one or more networks 31. In various embodiments, external services 37 may comprise web-enabled services or functionality related to or installed on the hardware device itself. For example, in one aspect where client applications are implemented on a smartphone or other electronic device, client applications may obtain information stored in a server system 32 in the cloud or on an external service 37 deployed on one or more of a particular enterprise's or user's premises.

In some embodiments, clients 33 or servers 32 (or both) may make use of one or more specialized services or appliances that may be deployed locally or remotely across one or more networks 31. For example, one or more databases 34 may be used or referred to by one or more embodiments. It should be understood by one having ordinary skill in the art that databases 34 may be arranged in a wide variety of architectures and using a wide variety of data access and manipulation means. For example, in various embodiments one or more databases 34 may comprise a relational database system using a structured query language (SQL), while others may comprise an alternative data storage technology such as those referred to in the art as “NoSQL” (for example, HADOOP CASSANDRA™, GOOGLE BIGTABLE™, and so forth). In some embodiments, variant database architectures such as column-oriented databases, in-memory databases, clustered databases, distributed databases, or even flat file data repositories may be used according to the aspect. It will be appreciated by one having ordinary skill in the art that any combination of known or future database technologies may be used as appropriate, unless a specific database technology or a specific arrangement of components is specified for a particular aspect described herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, some embodiments may make use of one or more security systems 36 and configuration systems 35. Security and configuration management are common information technology (IT) and web functions, and some amount of each are generally associated with any IT or web systems. It should be understood by one having ordinary skill in the art that any configuration or security subsystems known in the art now or in the future may be used in conjunction with embodiments without limitation, unless a specific security 36 or configuration system 35 or approach is specifically required by the description of any specific aspect.

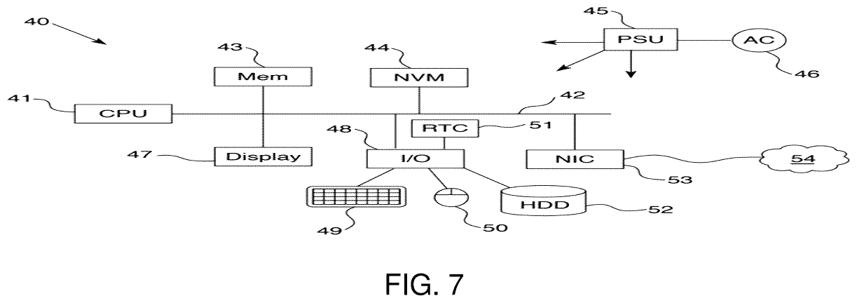

FIG. 7 shows an exemplary overview of a computer system 40 as may be used in any of the various locations throughout the system. It is exemplary of any computer that may execute code to process data. Various modifications and changes may be made to computer system 40 without departing from the broader scope of the system and method disclosed herein. Central processor unit (CPU) 41 is connected to bus 42, to which bus is also connected memory 43, nonvolatile memory 44, display 47, input/output (I/O) unit 48, and network interface card (NIC) 53. I/O unit 48 may, typically, be connected to keyboard 49, pointing device 50, hard disk 52, and real-time clock 51. NIC 53 connects to network 54, which may be the Internet or a local network, which local network may or may not have connections to the Internet. Also shown as part of system 40 is power supply unit 45 connected, in this example, to a main alternating current (AC) supply 46. Not shown are batteries that could be present, and many other devices and modifications that are well known but are not applicable to the specific novel functions of the current system and method disclosed herein. It should be appreciated that some or all components illustrated may be combined, such as in various integrated applications, for example Qualcomm or Samsung system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various embodiments, functionality for implementing systems or methods of various embodiments may be distributed among any number of client and/or server components. For example, various software modules may be implemented for performing various functions in connection with the system of any particular aspect, and such modules may be variously implemented to run on server and/or client components.

The skilled person will be aware of a range of possible modifications of the various embodiments described above. Accordingly, the present invention is defined by the claims and their equivalents.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for facilitating database queries through the disclosed principles herein. Thus, while particular embodiments and applications have been illustrated and described, it is to be understood that the disclosed embodiments are not limited to the precise construction and components disclosed herein. Various apparent modifications, changes and variations may be made in the arrangement, operation and details of the method and apparatus disclosed herein without departing from the spirit and scope defined in the appended claims.

What is claimed is:

1. A graphical user interface (GUI) for enabling an inventory check, the graphical user interface comprising:
a first UI element comprising an inventory management screen, the first UI element further comprising a first UI subelement, a second UI subelement, a third UI subelement and a first interactive UI element;
wherein the first UI subelement of the first UI element displaying a class of inventory items associated with a first user;
wherein the second UI subelement of the first UI element displaying a first serial number associated with at least the class of inventory items;
wherein the third UI subelement of the first UI element displaying a first subcomponent associated with a first serial number;
wherein the first interactive UI subelement of the first UI element is capable of receiving user input to identify a quantity on hand;
wherein once a user completes interaction with the first interactive subelement, the second UI subelement displays at least one of a secondary serial number for a second inventory item associated with the class of inventory items and wherein after input has been received for each first subcomponent for each serial number associated with the class of inventory items, the third UI subelement display changes to at least one secondary subcomponent.

2. The GUI according to claim 1, further comprises a database comprising at least the hierarchy tree defining a first user to secondary user relationships, at least one class of inventory items, at least one serial number and associated user, and at least one subcomponent and their associations to the classes of inventory items.

3. The GUI according to claim 1, further comprising a fourth UI subelement of the first UI element displaying the quantity of a subcomponent associated with a first user.

4. The GUI according to claim 3, wherein quantity recorded is stored in an inventory management database associated with the first user.

5. The GUI according to claim 1, further comprising a fifth UI subelement of the first UI element displaying the quantity of a subcomponent on order.

6. The GUI according to claim 1, further comprising a sixth UI subelement of the first UI element displaying an image of the subcomponent.

7. The GUI according to claim 1, further comprising a seventh UI subelement of the first UI element displaying textual information on properties of the subcomponent.

8. The GUI according to claim 1, further comprising an eighth UI subelement of the first UI element displaying the quantity of a subcomponent on hand

9. The GUI according to claim 1, wherein the first interactive UI subelement of the first UI element also displays a functional status of the subcomponent.

10. The GUI according to claim 1, wherein the first interactive UI subelement of the first UI element further comprises a second interactive UI subelement of the first UI element capable of receiving user input to complete the inventory check of the subcomponent

11. The GUI according to claim 10, wherein once a user submits/completes interaction with the second interactive subelement of the first UI element, the second UI subelement of the first UI element displays at least one a secondary serial number and after input has been received for each first subcomponent for each serial number associated with the first user, the third UI subelement of the first UI element display changes to at least one a secondary subcomponent.

12. The GUI according to claim 11, further comprising a fourth UI subelement of the first UI element displaying the quantity of a subcomponent associated with a first user; a fifth UI subelement of the first UI element displaying the quantity of a subcomponent on order; an eighth UI subelement of the first UI element displaying the quantity of a subcomponent on hand; wherein once a user submits interaction with the first UI interactive subelement of the first UI element, the fourth and fifth UI subelements of the first UI element change to reflect quantities associated with the second new subcomponent.

13. The GUI according to claim 1, wherein the first interactive UI subelement includes an all components are functional selection wherein interaction with the selection fills in the last known quantity in the function box.

14. The GUI according to claim 1, wherein the first interactive UI subelement includes a check component type later selection wherein interaction with this selection skips the check of the component.

15. The GUI according to claim 1, wherein the first interactive UI subelement includes a check component instance later selection wherein interaction with this selection skips a single check for the component.

16. The GUI according to claim 1 further comprising:
a second UI element displaying at least one class of inventory items that is associated with a first user, the association set forth in a first data set comprising a hierarchical responsibility tree, wherein the second UI element comprises first UI subelement, second UI subelement, third UI subelement, fourth UI subelement, and a first interactive UI subelement
wherein the first UI subelement of the second UI element displays a class of inventory item
wherein the second UI subelement of the second UI element displays at least one serial number associated with the class of inventory item
wherein the third UI subelement of the second UI element displays information associated with at least one secondary user;
wherein the fourth UI subelement of the second UI element displays a group assignment associated with the secondary user
wherein the first interactive UI subelement of the second UI element receives user input to indicate serial numbers of interest and perform an inventory check on the indicated serial numbers.

17. The GUI according to claim 1, wherein the at least one secondary user is a subordinate of the first user.

18. The GUI according to claim 1, wherein the user input on the first interactive UI subelement of the second UI element is capable of displaying the first UI element

19. The GUI according to claim 1 further comprising:
a third UI element displaying at least one class of inventory items that is associated with a first user, the association set forth in a first data set comprising a hierarchical responsibility tree, wherein the third UI element comprises first UI subelement, second UI subelement, third UI subelement, and a first interactive UI subelement;
wherein the first UI subelement of the third UI element displays a class of inventory item;
wherein the second UI subelement of the third UI element displays at least one serial number associated with the class of inventory item;
wherein the third UI subelement of the third UI element displays information associated with at least one secondary user;
wherein the first interactive UI subelement of the second UI element receives user input to indicate serial numbers of interest and assign responsibility of the indicated serial numbers to the at least one secondary user.
